(19) United States
(12) Patent Application Publication
(10) Pub. No.: US 2010/0195853 A1
(43) Pub. Date: Aug. 5, 2010

(54) Electrical Connector for a Hearing Device

(75) Inventor: Thomas Joschika, Braedstrup (DK)

Correspondence Address: Mollborn Patents, Inc., 2840 Colby Drive, Boulder, CO, 80305, US

(73) Assignee: ESTRON A/S, Them (DK)

(21) Appl. No.: 12/678,289

(22) PCT Filed: Oct. 16, 2007
(86) PCT No.: PCT/DK2007/000445

§ 371 Date: Apr. 12, 2010

(51) Int. Cl. H04R 25/00; H01R 4/58; H01R 43/00

(52) U.S. Cl. 381/312; 439/86; 29/854

(57) ABSTRACT

This invention relates to an electrical connector for generating an electrical connection between at least a first electric conductor and at least a second electric conductor, e.g. for generating an electrical connection between the lead wires of a connector mounted between the ear side unit and receiver of a hearing device and the receiver, wherein said electrical connection is based on pressure of at least one of said conductors against a pressure-sensitive conductive elastomer fixated between said at least two electric conductors. The present invention further relates to a hearing device comprising an ear side unit, a receiver and an electrical connection between said ear side unit and said receiver, wherein said electrical connection comprises at least an electrical connector as described above. The invention also relates to a method of generating an electric connection between at least a first electrical conductor.

### FIELD OF THE INVENTION

The present invention relates to electrical connectors and especially electrical connectors for generating an electrical connection between the lead wires connecting the receiver and ear side unit of a hearing device and the receiver.

### BACKGROUND OF THE INVENTION

Headsets and hearing devices often comprise an ear side unit placed behind the ear and a receiver (loudspeaker) placed in or near the ear channel. The ear side unit comprises, in connection with hearing devices, a number of microphones for detecting sounds and a data handling and amplifier unit for data handling and amplification of the sound signals recorded by the microphone. The data handled and amplified sound signals are hereafter transmitted to the receiver through lead wires drawn from the ear side unit to the receiver, where the sound signals would be converted into sounds waves inside the ear channel and thereby improving the user's listening skills. The ear side unit could in connection with headsets instead of microphones for instance comprise a radio receiver for receiving sound signals transmitted as radio waves (FM, AM, Bluetooth, etc.) and thereby enable the user to receive and hear sound signals transmitted as radio signals.

The lead wires connecting the ear side unit and the receiver are typically drawn through a sound tube. The sound tube and receiver are typically connected such that both the sound tube and receiver need to be replaced in case of malfunction or breakdown of the sound tube or receiver, which is both time-consuming and expensive. The lead wires are typically brazed to the receiver, and both the sound tube and receiver are therefore replaced in case that the sound tube and lead wires break as it is very time-consuming to replace only the sound tube. Another problem in this connection is the fact that the ear is different from person to person, and therefore the hearing device manufacturers need to supply different receivers with lead wires of different lengths for each hearing device such that the audiologists can adjust the hearing device to the user. Today, the manufacturers braze the receiver to the lead wires and therefore they need to supply one receiver per different length of lead wire. There is further a risk that the receiver might be damaged when brazing the lead wires to the receiver as heat may be conducted through the electric conductors of the receiver and thus damage the electrical components or circuit.

### OBJECT AND SUMMARY OF THE INVENTION

It is an object of the invention to overcome some or all of the above-mentioned problems.

This is achieved by the invention as defined by the independent claims, and other advantageous embodiments of the invention are defined by the dependent claims. The benefits and advantages of the present invention are explained and discussed in the detailed description.

### BRIEF DESCRIPTION OF THE DRAWINGS

In the following, preferred embodiments of the invention will be described referring to the figures, where

FIGS. 1a and 1b illustrate a hearing device according to prior art comprising a connector connecting the ear side unit and receiver of the hearing device;

FIGS. 2a and 2b illustrate an embodiment of a connector connecting the ear side unit and receiver of a hearing device, and which comprises an electric connector according to the present invention.

FIG. 3 illustrates an enlarged view of the assembled electrical connector according to the present invention.

### DESCRIPTION OF EMBODIMENTS

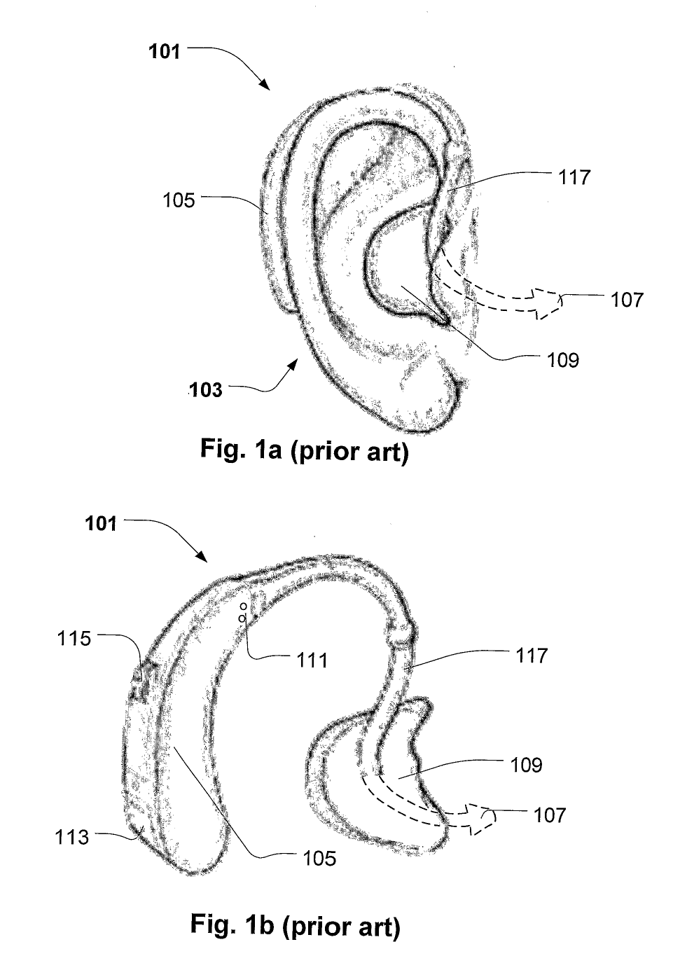

FIGS. 1a and 1b illustrate a hearing device as known in the prior art, where FIG. 1a illustrates how the hearing device (101) is placed on the ear (103) and FIG. 1b illustrates the hearing device without the ear. The hearing device comprises an ear side unit (105) placed behind the ear, a receiver (107) placed within the ear channel (109) or could in other embodiments be placed near the ear channel. The ear side unit comprises a microphone array (111), a battery chamber (113) for power supplying of the hearing device, a volume control (115) enabling the user to turn the volume up and down and a processing and amplifying unit (not shown since it is enclosed). The microphones record the sound and convert the acoustic signals into electric signals, and the processing and amplifying unit would hereafter typically filter and amplify the electric signals. The processing and amplifying unit could be implemented as analog units, digital units or a combination of both analog and digital units. The ear side unit is through a sound tube (117) connected to the receiver (107) typically integrated into a receiver housing which fits the user's ear channel. The sound tube comprises a number of lead wires (not shown) drawn through the sound tube, and the lead wires are connected to the processing and amplifying unit at the ear side unit and to the receiver. The receiver housing and sound tube typically engage with each other and the lead wires could therefore be drawn out of the sound tube and into the receiver housing where they are brazed to the electrical conductors of the receiver. Thereby the processed and amplified signals could be transmitted from the ear side unit behind the ear to the receiver inside the ear channel, where the receiver converts the electric signals into acoustic signals. The sound tube is made of a relatively stiff material and adapted to fit around the ear (103) and to positioning the ear side unit behind the ear and the receiver inside the ear channel as illustrated in FIG. 1. There is always a risk that some of the components of the hearing device could break and thus must be repaired or replaced. Both the receiver and the sound tube are typically replaced in case that either the sound tube or receiver is broken since it is very complicated and time-consuming to replace only one of these components. The reason for this is the fact that the lead wires need to be brazed of the receiver which is a complicated process as the size of lead wires and conductors of the receiver are very small, and further there is a risk that the receiver might be damaged when brazed. The manufacturers therefore find is easier to replace both components rather than replacing the broken component, and there is therefore a large waste of components, especially when only the sound tube breaks because then the more expensive receiver is often discarded.

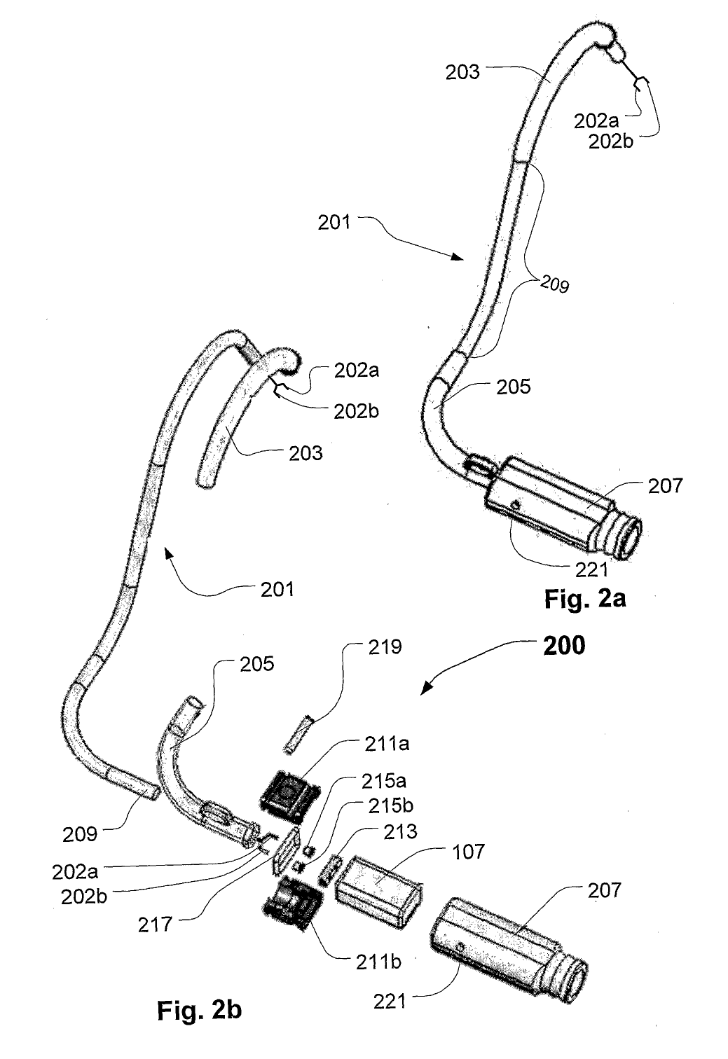

FIGS. 2a and 2b (an exploded view) illustrate an embodiment of a is connector (201) connecting the ear side unit (not shown) and receiver (107) of a hearing device, and which comprises an electric connector (200) according to the present invention.

The receiver is in the illustrated embodiment placed in a receiver housing (207) that can be positioned in the user's ear channel. The receiver housing can have many different shapes and forms depending on the manufacture specifications. The connector (201) is in this embodiment constructed as an isolated wire comprising a number of twisted lacquered conducting wires (202a, 202b) onto which an outer isolating jacket (209) has been extruded. Each lacquered conducting wires comprises in one embodiment a number of lacquered magnet wires that are twisted together and form a helix. One or more of the magnet wires could be colored and thereby form a tracer for easy identification of each lacquered conducting wire. The lacquer could for instance be polyamide. By lacquering the magnet wires individually they can be displaced relatively to each other and they therefore form a very flexible and soft lacquered wire. The twisted lacquered conducting wires are isolated from each other due to the lacquer. The connector could in another embodiment alternatively be constructed as a tube made of a soft and flexible material, where the lead wires are drawn/pushed through the tube. The ends (202a, 202b) of the twisted lacquered conducting wires can be connected to the receiver (107) and to the ear side unit. In the shown embodiment the soft and flexible connector (201) further comprises an ear side stiffener (203) formed as a stiff tube that is fastened to the ear side unit and shaped as a curve such that it fits around the upper part of the ear helix. The connector (201) is therefore drawn through the ear side stiffener (203) and enters the ear side unit where the lead twisted lacquered wires (202a, 202b) are connected to the electrical means of the ear side unit, e.g. by brazing or by using an electric connector as described below. In the illustrated embodiment the ends of the lead twisted lacquered wires each comprises a conductor shoe (215a, 215b) which is brazed to the ends. The ear side stiffener (203) would therefore be able to fixate the ear side unit behind the ear. The connector further comprises a receiver side stiffener (205) formed as a stiff tube connected to a receiver housing (207) shaped to fit the entrance of the ear channel such that the receiver housing (207) would be maintained in a position inside the ear channel. The receiver housing (207) surrounds the receiver (107), and the twisted lacquered wires (202a, 202b) enter the receiver housing through the receiver side stiffener (205) and they can thus be connected to the receiver inside the receiver housing.

The electrical connector (200) according to the present invention is comprised in the receiver housing and comprises a pair of connector housings (211a, 211b), a pressure-sensitive conductive elastomer contact (213), an o-ring (217) and a dowel pin (219). The pair of connector housings are adapted to secure the receiver side stiffener when welded or clamped together and fixated by e.g. adhesive and/or the o-ring. The o-ring further prevents air, moist and dirt fro entering the receiver housing. The isolated wire/lead wires would therefore enter the electrical connector (200) through the receiver side stiffener (205), and the conductor shoes (215a, 215b) of the lacquered conducting wires (202a, 202b) would be secured adjacent to the pressure-sensitive conductive elastomer contact (213). The conductor shoes can in another embodiment be omitted, and the ends of the lead wires are then secured adjacent to the pressure-sensitive conductive elastomer. The isolated wire comprises in one embodiment a strength fiber which could be secured to the connector housings (211a, 211b) at a securing area (315). When assembled the electrical connecter is inserted into the receiver housing (207) and secured by the dowel pin (219), which is inserted in a dowel hole (221) in the receiver housing (207). The pressure-sensitive conductive elastomer contact would then get in contact with the electric conductors of the receiver and the electrical conductor shoes (215a, 215b) of the twisted lacquered wires (202a, 202b) and become electrically conducting as the dowel pin provides pressure connector housings (211a, 211b) such that the pressure-sensitive conductive elastomer is squeezed/pinched between the receiver conductors and conductor shoes. The pressure-sensitive conductive elastomer compound exhibits high resistance (insulating performance) when it is in non-pressed/squeezed/pinched condition and the resistance of which, as the compound is pressed/squeezed/pinched, varies according to the magnitude of the pressure. The elastomer therefore become electrically conducting when put on pressure. The pressure-sensitive conductive elastomer could for instance be produced as described in U.S. Pat. No. 5,175,214 incorporated herein by reference or could e.g. be the Zebra® Carbon, Zebra® Silver, Zebra® Gold elastomers from Fujipoly® or other pressure-sensitive conductive elastomer provided by Shin-Etsu Polymer.

It is possible to design and build a very small electric connection which could e.g. be used in connection with hearing devices by using a pressure-sensitive conductive elastomer when creating an electric connector as there are less requirements to tolerances when using the pressure-sensitive conductive elastomer compared to when using only mechanical contacts. The conductors between which an electrical connection needs to be established simply need to be pressed against the pressure-sensitive conductive elastomer in order to establish electrical connection there between. In contrast hereto a mechanical connection typically comprises a male and female plug that must be designed to fit each other, and therefore large tolerances to the plugs are required when creating very small connections.

In connection with hearing devices the electric connector (200) makes it possible to replace the isolated wire or the receiver very fast and easy. The dowel pin (219) would in this case be pushed out of the dowel hole (221) and the connector housings could then be separated where after the connector shoes (215a, 215b) of the isolated wire (201) could easily be removed from the connector housing. The connector shoes of a new isolated wire could then easily be replaced adjacent to the elastomer contact (213), and a new electrical contact between the lead wire and receiver could then be established by assembling the electric connector again. The receiver could of course also be replaced in a similar way. Hereby is achieved that the lead wires or receiver could be replaced without brazing at the receiver and thereby it is prevented that the receiver is damaged when brazing. Further, the hearing device manufacturer only needs to supply one receiver per hearing device as it is now possible to supply a number of lead wires which could easily be connected with the receiver, with different lengths along with the receiver. As a consequence, many resources are saved.

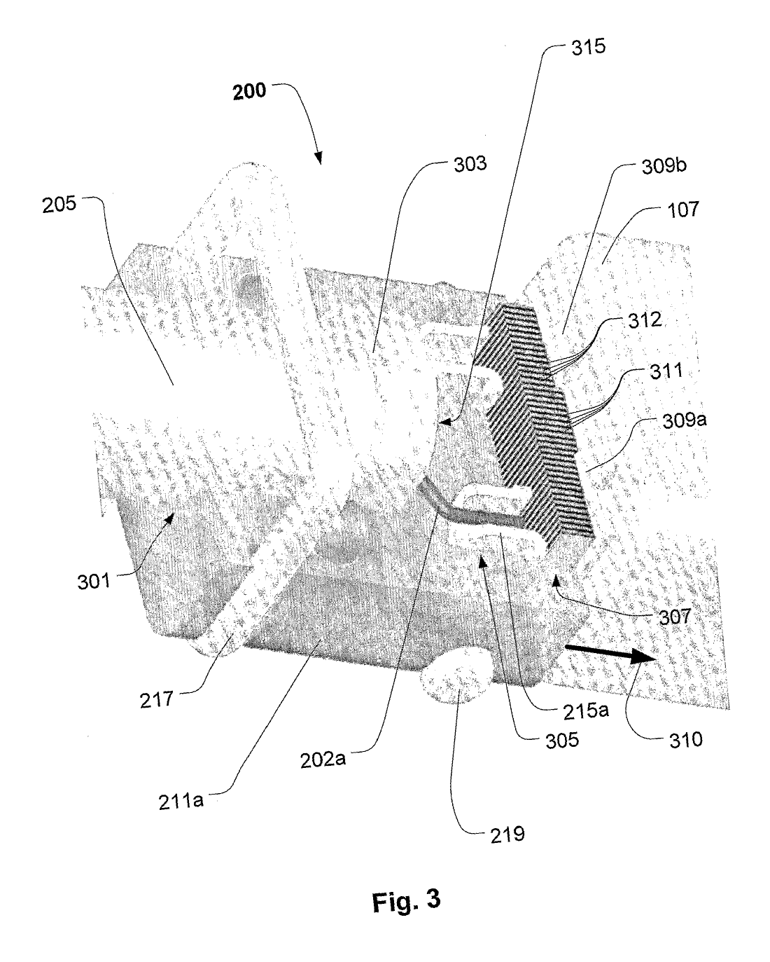

FIG. 3 illustrates an enlarged view of the assembled electrical connector (200) where the receiver housing (207) and one of the connector housings (211b) have been removed. The connector housing (211a) comprises a stiffener recess (301) into which the receiver side stiffener (205) fits, and the receiver side stiffener comprises an annular flange (303) which is secured in a widening in the recess (301). The connector further comprises a number of conductor shoe recesses (305) into which the conductor shoes (215a) of the lacquered conducting lead wires (202a) fit. The conductor shoes (215a) are in the illustrated embodiment embodied as u-shaped shoes formed in an electrical conducting material, and the ends of the lacquered conduction wires are inserted into the u-shape. The lacquered conduction wires could be brazed to the conductor shoes in connection with the production of the isolated wire, or the shoes could be squeezed together around the ends of the lacquered wires. The connector housing further comprises an elastomer recess (307) into which the pressure-sensitive conductive elastomer contact (213) fits and it is placed adjacent to the conductor shoe recesses such that the conductor shoes would be placed adjacent to the elastomer contact. The elastomer contact is on the other side placed adjacent to the electrical conductors (309a, 309b) of the receiver (107).

The receiver is fixated inside the receiver housing and the connector housings (211a, 211b) would be pushed towards the receiver housing as illustrated by arrow (310) when the dowel pin (219) is inserted into the dowel hole. The result is that the elastomer contact would be pressed/squeezed/pinched between the conductor shoes (215a, 215b) of the lead wires and the conductors of the receiver (309a, 309b) and thereby create an electric connection there between.

The elastomer used in the illustrated embodiment is a Zebra® Silver from Fujipoly which comprises a large number of layers of isolating material (311, illustrated as dark strips), which in contrast to the other parts of the elastomer contact does not become electrical conducting when put under pressure, separated by layers of pressure-sensitive elastomer (312, illustrated as bright strips) based on silver stings. The isolating parts would therefore isolate the electric contacts (309a, 309b) and thus prevent short circuits there between. Alternatively, the elastomer could comprise two conducting sections separated by a single isolating section, or the electric connector could be constructed such that only the parts of the pressure-sensitive conducting elastomer that are placed just beside the conductors would be squeezed, and the middle section of the elastomer would therefore not be squeezed and thus not be electrically conducting.

It is to be understood that the illustrated embodiments only serve as illustrating examples rather than limiting the scope of the claims. A person skilled in the art may be therefore able to construct alternative embodiments within the scope of the claims.

1. An electrical connector for generating an electrical connection between at least a first electric conductor and at least a second electric conductor, e.g. for generating an electrical connection between the lead wires of a connector mounted between the ear side unit and receiver of a hearing device and the receiver, wherein said electrical connection is based on pressure of at least one of said conductors against a pressure-sensitive conductive elastomer fixated between said at least two electric conductors.

2. An electrical connector according to claim 1, wherein said electrical connector comprises fixating means adapted to fixate said pressure-sensitive conductive elastomer and pressing means adapted to press at least one of said conductors against said pressure-sensitive conductive elastomer.

3. An electrical connector according to claims 1-2, wherein said electrical connector comprises at least one connector housing fixating said at least first conductor and said pressure-sensitive conductive elastomer adjacent to each other.

4. An electrical connector according to claims 2 and 3, wherein said pressing means being adapted to press said connector housing against said at least second conductor whereby said second conductor being pressed against said pressure-sensitive conductive elastomer fixated by said housing.

5. An electrical connector according to claims 1-4, wherein said at least first conductor is the conductor of a lead wire connecting the ear side unit and receiver of a hearing device.

6. An electrical connector according to claims 1-5, wherein said at least second conductor is the conductor of a receiver of a hearing device.

7. An electrical connector according to claim 6, wherein said connector housing is adapted to be inserted into a receiver housing comprising the receiver, and wherein said pressuring means are adapted to press said connector housing against said receiver whereby said conductors of said receiver are pressed against said pressure-sensitive conductive elastomer.

8. A connector to be mounted between the receiver and the ear side unit of a hearing device, said connector comprises at least one lead wire for electrically connecting said ear side unit and said receiver, wherein said connector further comprises at least one electrical connector according to claims 1-7.

9. A hearing device comprising an ear side unit, a receiver and an electrical connection between said ear side unit and said receiver, wherein said electrical connection comprises at least an electrical connector according to claims 1-8.

10. A method of generating an electric connection between at least a first electrical conductor and at least a second electrical conductor, e.g. for generating an electrical connection between the lead wires of a connector mounted between the ear side unit and receiver of a hearing device and the receiver, wherein said method comprises the step of:
pressing at least one of said conductors towards a pressure-sensitive conductive elastomer positioned between said two electric conductors.
